(19) United States
(12) Patent Application Publication
(10) Pub. No.: US 2016/0053120 A1
(43) Pub. Date: Feb. 25, 2016

(54) AZO DYE USED FOR A COLOR FILTER OF A LCD

(71) Applicant: DOW GLOBAL TECHNOLOGIES LLC, Midland, MI (US)

(72) Inventors: Nan HU, Shanghai (CN); Xinyu Cao, Shanghai (CN); Xiangyang Tai, Shanghai (CN); Tianhui Xiao, Shanghai (CN); Guihong Liao, Shanghai (CN)

(21) Appl. No.: 14/783,441

(22) PCT Filed: Apr. 27, 2013
(86) PCT No.: PCT/CN2013/074911

§ 371 Date: Oct. 9, 2015

(51) Int. Cl. C09B 29/08; G02F 1/1335

(52) U.S. Cl. CPC C09B 29/081; G02F 1/133514

(57) ABSTRACT

An azo dye which is suitable for forming a color filter used for a liquid crystal display device, a composition containing an alkaline soluble resin and the azo dye, an article having a polymer layer containing the azo dye and an alkaline soluble resin and a color filter containing the dye are developed.

### FIELD OF THE INVENTION

The present invention relates to an azo dye which is suitable for forming a color filter used for a liquid crystal display device, a composition containing an alkaline soluble resin and the azo dye, an article having a polymer layer comprising the azo dye and an alkaline soluble resin and a color filter comprising the dye.

### BACKGROUND OF THE INVENTION

Liquid crystal display (LCD) currently dominates the display market because of its excellent performance and small thickness. As a key component of LCD device, transparent color filters play the critical role of generating Red/Green/Blue lights by filtering white light from a back sheet. This capacity originates from the Red/Green/Blue colorants comprised in color filter units. Each colorant possesses a characteristic absorbance spectrum and will show one of the three primary colors when illuminated with white visible light-wavelength ranges from 380 nm to 780 nm. The controlled mixing of primary colors from each color filter unit produced by colorant will generate the final color of pixels. So the efficiency of color filter determines LCD's performance directly.

Normally, the commercialized colorants used in a LCD color filter are exclusively pigments, because they have good stability against heat, light and chemicals. Unfortunately pigments must be ground into micro/nano particles before added into a color resist to make a color filter due to their intrinsic insolubility property. When the color filter is illuminated, light scattering will take place on these particles with diameter of ˜100 nm. As a result lots of light signals will lose and transmittance will become low, which means more light energy must be applied to provide enough brightness of the LCD.

In contrast to pigments, dyes are soluble chemicals which ensure that they can be dispersed at molecular level. If dyes are used in a color filter instead of pigments, light scattering will be avoided. So it could be imagined that the dye based color filter will have higher transmittance and energy cost will thus be reduced greatly. However, dye's stability against light, heat and chemical resistance is generally inferior to pigments. As a result, at present, the commercialized LCD color filters are almost pigment with limited exceptions for a few of pigment-dye hybrid ones.

Some azo dyes are used for a color filters of a LCD. Various heterocyclic azo dyes and phenylazonaphalene sulfonate dyes have been proposed for color filters, see e.g. U.S. Pat. No. 7,354,965B, U.S. Pat. No. 7,740,995B, US20090092802A, U.S. Pat. No. 6,533,852B, U.S. Pat. No. 6,248,482B, U.S. Pat. No. 7,193,068B, U.S. Pat. No. 7,456,237B and JP09291241A, but these dyes generally have insufficient thermal stability or insoluble common organic solvent for a color filter.

Although the thermal stability of conventional azo dyes is not good, azo dye has great advantage in color performance. Azo dye is able to exhibit a variety of colors except blue, and its color is very bright especially for red color. Accordingly, an azo dye which is stable and satisfies the solubility in an organic solvent at the same time is still desired.

### SUMMARY OF THE INVENTION

Inventors of this invention have now found that new type of azo dye which is stable and has good solubility in an organic solvent. The azo dye is represented by the general formula (1)

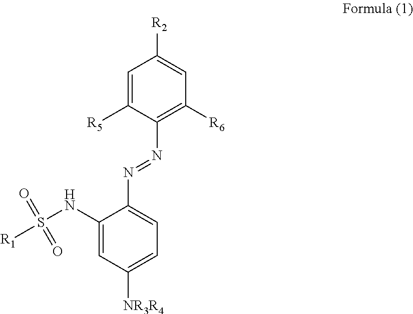

wherein R1 to R4 are independently selected from a group consisting of hydrogen atom, straight-chain, branched or cyclic alkyl group having 1-20 of carbon atoms, alkoxy group having 1-20 of carbon atoms, aryl group having 6-20 of carbon atoms, and aryloxy group having 6-20 of carbon atoms. At least one of R3 and R4 is straight-chain, branched or cyclic alkyl group having 1-20 of carbon atoms, alkoxy group having 1-20 of carbon atoms, aryl group having 6-20 of carbon atoms, or aryloxy group having 6-20 of carbon atoms. R5 and R6 are independently selected from —CN group and halogen atom.

These azo dyes which have azobenzene structure contain intramolecular hydrogen bond, resulting in significantly enhanced the thermal stability In addition, such azo dye has high enough solubility for an organic solvent due to the organic side groups of the azo dye, so the azo dye of this invention is useful for a color filter used in a LCD.

### DETAILED DESCRIPTION OF THE INVENTION

As used throughout this specification, the abbreviations given below have the following meanings, unless the context clearly indicates otherwise: g=gram; mg=milligram; mm=millimeter; min.=minute(s); s=second(s); hr.=hour(s); rpm=revolution per minute; ° C.=degree Centigrade. Throughout this specification, “(meth)acrylic” is used to indicate that either “acrylic” or “methacrylic” functionality may be present. As used throughout this specification, the word ‘resin’ and ‘polymer’ is used interchangeably. The word ‘alkaline soluble resin’ and ‘binder’ is used interchangeably.

<Azo Dye>

The present invention provides an azo dye represented by the general formula (1).

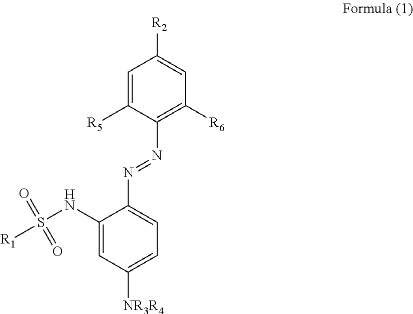

R1 to R4 of the formula (1) are independently selected from a group consisting of hydrogen atom, straight-chain, branched or cyclic alkyl group, alkoxy group, aryl group and aryloxy group.

The straight-chain alkyl group has at least 1 carbon atom, and has less than 20 carbon atoms, preferably less than 8 carbon atoms. The branched or cyclic alkyl group has at least 3 carbon atoms, and has less than 20 carbon atoms, preferably 8 carbon atoms. Examples of straight-chain, branched or cyclic alkyl group used for R1 to R4 of the formula (1) are, methyl, ethyl, propyl, butyl, hexyl, octyl, decyl, dodecyl, hexadecyl, octadecyl, isopropyl, sec-propyl, sec-butyl, tert-butyl, 2-ethylhexyl, cyclohexyl, 1-norbornyl and 1-adamantyl. The alkoxy group has at least 1 carbon atom, and has less than 20 carbon atoms, preferably 8 carbon atoms. Examples of alkoxy group used for R1 to R4 of the formula (1) are, methoxy, ethoxy, propoxy, n-butoxy, tert-butoxy, isopentyloxy, n-pentyloxy, n-hexyloxy, cyclohexyloxy and 2,3-dimethylbutoxy.

The aryl group has at least 6 carbon atoms, and has less than 20 carbon atoms, preferably less than 10 carbon atoms. Examples of aryl group used for R1 to R4 of the formula (1) are, phenyl, benzyl, tolyl, xylyl, mesitylyl, biphenyl, naphtyl, anthryl and phenanthryl.

The aryloxy group has at least 6 carbon atoms, and has less than 20 carbon atoms, preferably less than 10 carbon atoms. Examples of aryloxy group used for R1 to R4 of the formula (1) are, phenoxy, benzoxy, tolyloxy, xylyloxy, mesitylyloxy, biphenyloxy, naphtyloxy, anthryloxy and phenanthryloxy.

In the formula (1), at least one of R3 and R4 is straight-chain, branched or cyclic alkyl group, alkoxy group, aryl group, or aryloxy group having the above mentioned carbon atoms.

Preferably, both of R3 and R4 are straight-chain, branched or cyclic alkyl group, alkoxy group, aryl group, or aryloxy group.

R5 and R6 are independently selected from —CN group and halogen atom.

The azo dye of the present invention can be used as a mixture of azo dyes which have different substituents.

The azo dye of the present invention can be synthesized by the known process such as disclosed in Society of Dyers and Colourists, Color. Technol., 124, 92-99 (2008). Example of a proess for synthesize the dye shown in formula (2) is disclosed below.

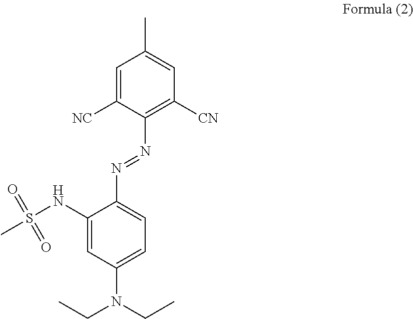 [SMILES: CCN(CC)c1ccc(/N=N/c2c(C#N)cc(C)cc2C#N)c(NS(C)(=O)=O)c1]

0.04 mol of 2-amino-5-methylisophthalonitrile is added to a solution of concentrated 40 mL of hydrochloric acid (35%) with 250 mL of water. The mixture is stirred for 2 hours at room temperature, then cooled to 5° C. 0.042 mol of sodium nitrite (NaNO₂) is added portionwise at 5-10° C. The mixture is stirred for 5 hours within the same temperature range. The resulting solution is used immediately in the coupling reaction. The coupling component (0.036 mol of N-(3-(diethylamino)phenyl)-methanesulfonamide) is dissolved in 400 mL of water and 40 mL of hydrochloric acid (35%), then cooled to 0-5° C. by addition of ice. The diazonium solution previously prepared is added drop wise over 30 minutes at the same temperature. The mixture is stirred for a further 5 hours at 5-10° C. and sodium hydroxide (NaOH) solution (10%) is added slowly until the pH rise to a value of 3-4. The precipitated product is filtered off, washed with excess water and dried at 70-75° C. Product N-(2-(2,6-dicyano-4-methylphenethyl)-5-(diethylamino)phenyl)methanesulfona mide is obtained.

<Composition>

The composition of the present invention comprises at least one compound as recited in formula (1) and an alkaline soluble resin. The composition additionally comprises a crosslinkage, a solvent and a radiation-sensitive compound such as a photo initiator. The composition can form a film useful for a color filter.

The content of the compound as recited in formula (1) in the composition of the present invention varies depending on each molar absorption coefficient and required spectral characteristics, film thickness, or the like, but it is preferably at least 1 wt %, more preferably at least 2 wt % based on the entire solid contents of the composition. The preferable content is less than 80 wt %, more preferably less than 70 wt %, most preferably less than 50 wt % based on the entire solid contents of the composition.

The composition of the present invention can comprises other coloring materials in addition to the compound as recited in formula (1). Normally the use of additional coloring material is determined from the required spectral characteristics of a material to be formed from the composition.

The alkaline soluble resin is also known as ‘binder’ in this technical art. Preferably, the alkaline soluble resin is dissolved in an organic solvent. The alkaline soluble resin can be developed with an alkaline solution such as tetramethyl ammonium hydroxide aqueous solution (TMAH) after forming a film.

The alkaline soluble resin (binder) is normally a linear organic polymer. The binder optionally has a crosslinkable group within the polymer structure. When the composition of the present invention is used as a negative type photosensitive composition, such crosslinkable group can react and form crosslink by exposure or heating so that the binder becomes a polymer which is insoluble in alkaline.

Many kinds of binder are known in this art. Examples of such binder are; (meth)acrylic resin, acrylamide resin, styrenic resin, polyepoxyde, polysiloxane resin, phenolic resin, novolak resin, and co-polymer or mixture of those resins. In this application, (meth)acrylic resin (polymer) includes copolymer of (meth)acrylic acid or ester thereof and one or more of other polymerizable monomers. For example, acrylic resin can be polymerized from acrylic acid and/or acrylic ester and any other polymerizable monomers such as styrene, substituted styrene, maleic acid or glycidyl (meth)acrylate.

The binder preferably has at least 1,000 of weight-average molecular weight (Mw), more preferably at least 2,000 of Mw measured by a GPC method using a polystyrene as a standard. At the same time, the binder preferably has less than 200,000 of Mw, more preferably less than 100,000 of Mw measured by the same method described above.

The amount of the binder used in the composition of the present invention is preferably at least 10 wt %, more preferably at least 20 wt % based on the entire solid contents of the composition. At the same time, the preferable amount of the binder is less than 90 wt %, more preferably less than 80 wt % based on the entire solid contents of the composition.

The composition of this invention optionally further comprises a crosslinkage (crosslinking agent) to obtain a further hardened material. When the composition of this invention is used as a negative type photosensitive composition, such crosslinkage can form a crosslink by exposure or heating and contribute to get a further hardened material. Well known crosslikage can be used for the composition of this invention. Examples of crosslinkage are epoxy resin, substituted nitrogen containing compound such as melamine, urea, guanamine or glycol uril.

The composition of this invention optionally further comprises a solvent. The solvent to be used for the composition is not limited, but preferably selected from the solubility of components of the composition such as alkaline soluble resin or azo dye. Examples of the preferable solvent include esters such as ethylacetate, n-butyl acetate, amyl formate, butyl propionate or 3-ethoxypropionate, ethers such as diethylene glycol dimethyl ether, ethylene glycol monomethyl ether or propylene glycol ethyl ether acetate, ketones such as methylethylketone, cyclohexanone or 2-heptanone.

When the composition of this invention is a negative type radiation-sensitive composition, the composition preferably comprises a photo initiator. Photo initiator also called as photopolymerization initiator and including radical initiator, cationic initiator and anionic initiator. Examples of a photo initiator include; oxime esther type initiator, sulfonium salts initiator, iodide salts initiator and sulfonate initiator.

The composition of this invention can comprise other radiation-sensitive compound such as a radiation sensitive resin or a photo acid generator.

<Polymer Layer>

The composition of the present invention described above can form a polymer layer on an article. The polymer layer also described as ‘polymer film’ in the specification.

The contents of the compound as recited in formula (1) in the polymer layer is depend on the required color of the film, but at least 1 wt %, preferably at least 10 wt % based on the polymer layer. At the same time, the contents is less than 50 wt %, preferably less than 30 wt % based on the polymer layer. The polymer layer also comprises an alkaline soluble resin which is disclosed above.

The polymer layer optionally comprises a photo initiator, a photo acid generator, a radiation sensitive resin and a crosslink agent disclosed above.

The method of forming the polymer layer on an article comprises the steps of; mixing the compound as recited in formula (1) with an alkaline soluble resin and solvent, coating the mixture on an article which supports a layer and heating the article to form a polymer layer (film). Optionally, the method comprises one or more of steps of exposing a layer (film) or curing a layer to form crosslinked stable layer.

The solvent used to the film can be the solvent which can be used to the composition disclosed above.

Examples of an article which supports a layer (film) are glass, metal, silicon substrate and metal oxide coated material.

Any coating method can be used for the coating step, such as rotation coating, cast coating or roll coating.

The thickness of the layer (film) varies depending on the required properties of the film, but the polymer layer comprising the azo dye as recited in formula (1) could be thicker than the one comprising other pigments, because of its good solubility in an organic solvent. The thickness of the layer is 0.1 to 4 micron, preferably 0.5 to 3 micron.

The layer (film) has high transmittance and thermal stability from the properties of the azo dye of this invention. The azo dye can be dissolved in an organic solvent, and has high thermal stability. Therefore the dye does not prevent the transmittance of a film and does not decrease the thermal stability of the film. Such property is important for a color filter of LCD. Therefore, the layer (film) of the present invention is useful as a color filter of LCD.

<Color Filter>

The color filer of this invention comprises at least one compound as recited in formula (1). The layer (film) disclosed above can be used for the color filter. Normally, a color filter has multiple units which made from colored films comprising Red/Green/Blue colorants.

The contents of the compound as recited in formula (1) in a colored film for a color filter is same as the film disclosed above, at least 1 wt %, more preferably at meast 10 wt % based on total weight of the colored film. At the same time, the contents is less than 50 wt %, preferably less than 30 wt % based on total weight of the colored film.

A film used for a color filter can be formed by the following steps; coating a solution comprising the compound as recited in formula (1), binder, a photo initiator and solvent to form a radiation sensitive composition layer on a material, exposing the layer through a patterned mask, and developing the layer with an alkaline solution. Moreover, a curing step of further heating and/or exposing the layer after developing step may be conducted as needed.

Since a color filter comprises three colored films which comprise R/G/B colorant, the steps of forming each colored film are repeated, then a color filter having such three colored films are obtained.

### EXAMPLES

### Example 1

Azo dyes (Dye 1 and 2) disclosed below was used in example 1.

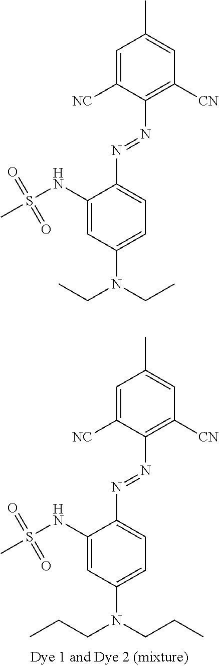

0.05 g of mixture of Dye 1 and Dye 2 (supplied from Yabang Co., Ltd, 97% purity), 1.6 g of cyclohexanone and 0.7 g of alkaline soluble acrylic resin (MIPHOTO RPR5200, supplied from Miwan Commercial Co., Ltd., 25-35% of solid content in methyl 3-methoxypropionate) were mixed and stirred for 5 minutes at room temperature. Then the solution was spin coated onto a glass plate (thickness: 1 mm, spinning rate: 400 rpm, time: 18 seconds) using KW-4A type spin coater made by Kunshan Lidian JingmiJixie Co., Ltd. The wet film was inserted in an oven and heated at 80° C. for 30 minutes, then at 150° C. for 15 minutes. Film thickness, transmittance and chromaticity coordinates of the obtained film were measured as disclosed below. Film thickness of the film was 0.9 micron, transmittance of the film was 97.7% based on glass plate coated by acrylic resin only. Chromaticity coordinates measured by UltraScan Pro (Hunterlab) colorimeter was, x=0.4093, y=0.2695 and Y=31.6.

The obtained dry film was baked at 200° C. under air for 1 hour to evaluate heat resistance. Optical performance measured by the difference between chromaticity coordinates of before and after baking (ΔE_{ab} value) was 4.9. A smaller ΔE_{ab} value indicates better heat resistance. The result is shown in Table 1.

<Performance Evaluation>

(1) Film Thickness:

Film thickness is measured by scanning the difference in height across the boundary of film and glass substrate with atomic force microscope.

(2) Transmittance:

The transmission peak of the color film in visible light range (wavelength: 380 nm˜780 nm) on glass sheet subtracted with the transmittance of glass sheet is employed to indicate the transmittance. The visible transmission spectrum is recorded by UltraScan Pro (Hunterlab) colorimeter.

(3) Chromaticity Coordinates:

The chromaticity coordinates of film are directly recorded with UltraScan Pro (Hunterlab) colorimeter. The light source is D65.

(4) Thermal Stability:

The wet films after spin coating are dried in oven at 80° C. for 30 minutes and then soft baked at 150° C. for 15 minutes. The chromaticity coordinates (L, a, b) are recorded with UltraScan Pro (Hunterlab) colorimeter. D65 light source is used and results are based on CIE Lab coordinates. After that the films are hard baked at target temperature (200° C.) for lhour and the new chromaticity coordinates (L′, a′, b′) are recorded with the method above. The thermal stability is indicated by the difference of chromaticity coordinate before and after hard baking represented by the following formula;

ΔE={square root over ((L−L′²+(a−a′)²+(b−b′)²)}.

TABLE 1

| | Examples | | | |
|---|---|---|---|---|
| | 1 | 2 | 3 | 4 |
| Solubility in cyclohexanone at | 4.0 | 6.4 | 4.3 | 6.4 |
| 25° C. (wt %) | | | | |
| Film thickness (micron) | 0.9 | 0.9 | 0.9 | 0.9 |
| Transmittance (%) | 97.7 | 98.1 | 97.3 | 97.2 |
| Thermal stability at 200° C. (ΔE_{ab}) | 4.9 | 43 | 15 | 64 |

### Example 2

### Comparative Example

Same procedure was conducted excepting for Dye 3 disclosed below (C.I. solvent yellow 16, supplied from Sanwei Co., Ltd) was used instead of Dye 1 and 2.

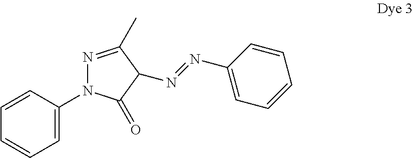 [SMILES: CC1=NN(c2ccccc2)C(=O)C1/N=N/c1ccccc1]

### Example 3

### Comparative Example

Same procedure was conducted excepting for Dye 4 disclosed below (C.I. solvent red 24, supplied from Yabang Co., Ltd) was used instead of Dye 1 and 2.

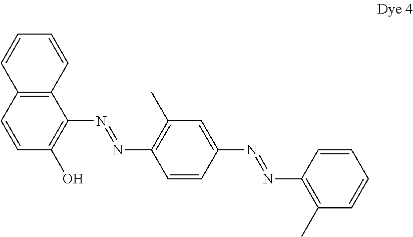 [SMILES: Cc1ccccc1/N=N/c1ccc(/N=N/c2c(O)ccc3ccccc23)c(C)c1]

### Example 4

### Comparative Example

Same procedure was conducted excepting for Dye 5 disclosed below (C.I. solvent yellow 14, supplied from Yabang Co., Ltd) was used instead of Dye 1 and 2.

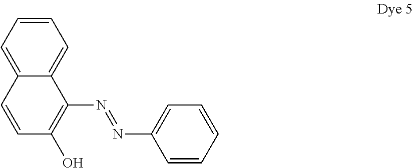 [SMILES: Oc1ccc2ccccc2c1/N=N/c1ccccc1]

Referring to Table 1, it can be found that the polymer films of comparative examples (Examples 2-4) have a very poor thermal stability. High thermal stability and fairly good solubility are both the advantages of the dyes of the present invention when it is used in color filter.

1-3. (canceled)

4. A composition comprising at least one compound as recited in the general formula (1) 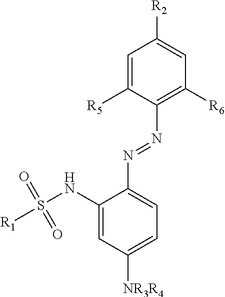
wherein R1 to R4 are independently selected from a group consisting of hydrogen atom, straight-chain, branched or cyclic alkyl group having 1-20 of carbon atoms, alkoxy group having 1-20 of carbon atoms, aryl group having 6-20 of carbon atoms, and aryloxy group having 6-20 of carbon atoms. At least one of R3 and R4 is straight-chain, branched or cyclic alkyl group having 1-20 of carbon atoms, alkoxy group having 1-20 of carbon atoms, aryl group having 6-20 of carbon atoms, or aryloxy group having 6-20 of carbon atoms. R5 and R6 are independently selected from —CN group and halogen atom;
and an alkaline soluble resin.

5. The composition of claim 4 wherein the contents of the compound as recited in the general formula (1) is 1 to 50% by weight based on the entire solid contents of the composition.

6. The composition of claim 4 wherein the alkaline soluble resin is acrylic resin.

7. An article having a polymer layer wherein the polymer layer comprises at least one compound as recited in the general formula (1) and an alkaline soluble resin.

8. The article of claim 7 wherein the contents of the compound as recited in the general formula (1) in the polymer layer is 1 to 30% by weight based on the polymer layer.

9. The article of claim 7 wherein the polymer layer is negative-type radiation sensitive layer.

10. A color filter comprising at least one compound as recited in the general formula (1).

11. A use of the compound as recited in the general formula (1) for a color filter of a LCD.
